(19) United States
(12) Patent Application Publication
(10) Pub. No.: US 2013/0343718 A1
(43) Pub. Date: Dec. 26, 2013

(54) PORTABLE ELECTRONIC DEVICE AND METHOD FOR CONTROLLING PLAYBACK OF MEDIA PLAYER

(71) Applicant: HON HAI PRECISION INDUSTRY CO., LTD., New Taipei (TW)

(72) Inventor: CHIH-CHUN CHANG, New Taipei (TW)

(73) Assignee: HON HAI PRECISION INDUSTRY CO., LTD., New Taipei (TW)

(21) Appl. No.: 13/869,267

(22) Filed: Apr. 24, 2013

(30) Foreign Application Priority Data
Jun. 21, 2012 (TW) 101122242

(51) Int. Cl. H04N 9/79

(52) U.S. Cl. CPC H04N 9/79
USPC 386/234

(57) ABSTRACT

A portable electronic device for controlling playback of a media player includes an image gathering unit, an image analyzing unit, and a communicating unit. The image gathering unit takes an image of the media player, including the current video frame and a background view around the media player. The image analyzing unit analyzes a color difference in the gathered image between the current video frame image and the back ground view image, and generates an image compensation signal based on the color difference. The communication unit transmits an image compensation signal to the media player to adjust the output of the video frames being displayed.

### BACKGROUND

1. Technical Field

The present disclosure relates to portable electronic devices, particular to a portable device and a method for controlling playback of a media player.

2. Description of Related Art

A media player, such as a television, a display, or a DVD player, outputs audio and video, but the outputted audio and video may not be clear due to environmental conditions, such as the sun light, lamplight, humidity, noise and so on. In order to hear and see the audio and video better, users may have to manually adjust the audio and video parameters numerous times. This is inconvenient and time consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a media playing system in accordance with an embodiment.

FIG. 2 is a function block diagram of the media playing system in FIG. 1.

FIG. 3 is a schematic view of an image taken by the media playing system in FIG. 1.

FIG. 4 is a flow chart of a control method for adjusting video of the media playing system.

FIG. 5 is a flow chart of a control method for adjusting audio of the media playing system.

### DETAILED DESCRIPTION

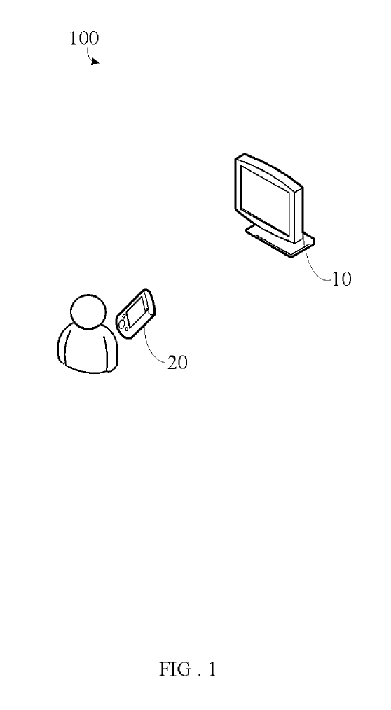

FIG. 1 shows a media playing system 100 which includes a media player 10 capable of displaying video and audio and a portable electronic device 20 for manipulating the media player 10. The portable electronic device 20 communicates with the media player 10 via wireless mode. In this embodiment, the portable electronic device 20 can be, but is not limited to being, a remote controller, a mobile phone, a PDA, or a palm computer. The media player 10 can be, but is not limited to being, a television, or other display. The wireless mode can be, but is not limited to being, a WIFI mode, BLUETOOTH mode, or infrared mode.

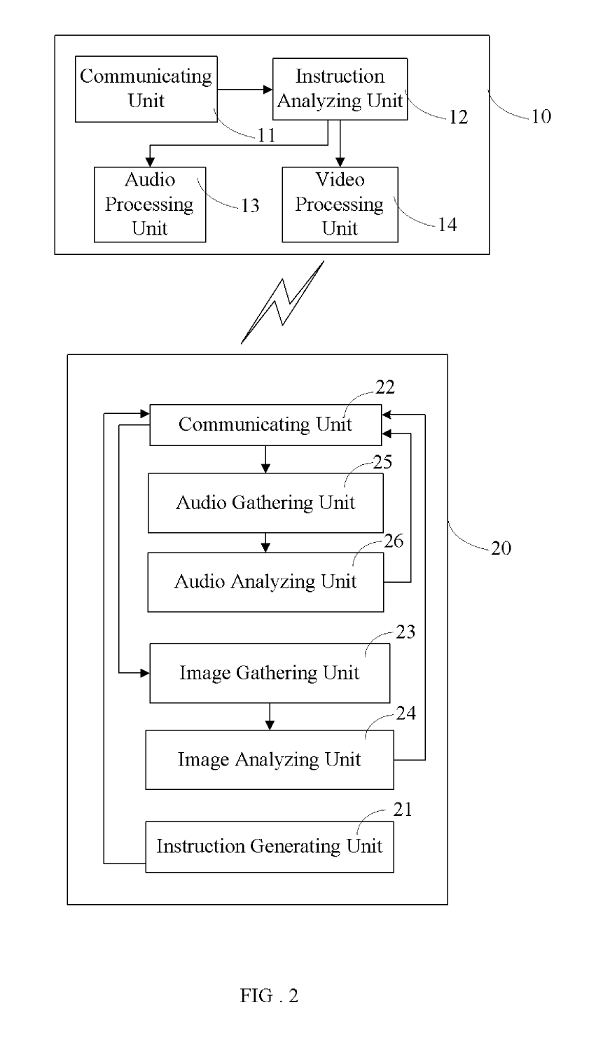

FIG. 2 shows that the portable electronic device 20 includes an instruction generating unit 21, a communicating unit 22, an image gathering unit 23, an image analyzing unit 24, an audio gathering unit 25, and an audio analyzing unit 26.

The instruction generating unit 21 generates a connecting signal in response to a user's operation.

The communicating unit 22 communicates with and instructs the media player 10 in response to the connecting signal, and generates a starting signal when the communicating unit 22 has communicated with the media player 10.

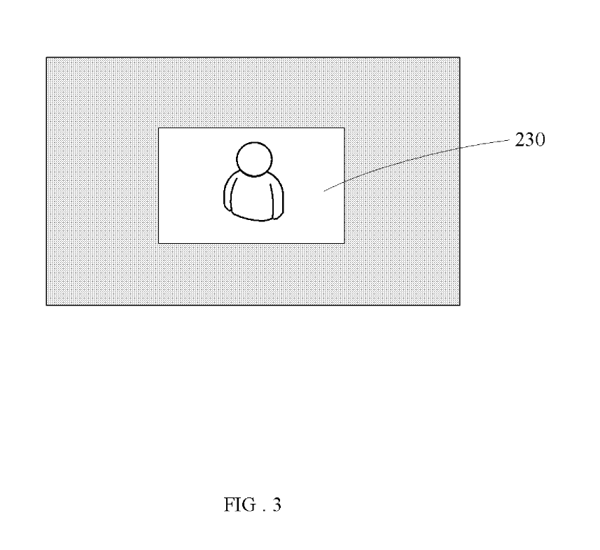

Referring to FIG. 3, the image gathering unit 23 takes an image of the media player 10 containing a current video frame displayed by the media player 10, and a background view around the media player 10 in response to the starting signal, and generates a first analyzing signal when the image is taken. In particular, the image gathering unit 23 includes a predetermined imaging region 230. The current video frame image is within the imaging region 230. The back ground view image is outside the predetermined imaging region 230. The gathered image is composed of the current video frame image and the back ground view image.

The image analyzing unit 24 analyzes a color difference between the video frame image and the back ground view image in response to the first analyzing signal, and generates a video compensation signal based on the color difference. The video compensation signal is transmitted to the media player 10 via the communicating unit 22. In particular, the image analyzing unit 24 compares the video frame image with the back ground view image to obtain the color difference between the video frame image and the back ground view image. The color difference can be, but is not limited to being, a color temperature difference, a luminance difference, or both a color temperature and luminance difference.

The audio gathering unit 25 collects all surrounding noises. The audio gathering unit 25 can be a microphone, and generates a second analyzing signal.

The audio analyzing unit 26 analyzes the noises, and generates an audio compensation signal. The audio compensation signal is transmitted to the media player 10 via the communicating unit 22. The noise in the surrounding noises can include the noise of construction and traffic for example (hereinafter referred to as ambient noises). In the embodiment, the audio compensation signal can be relevant to the volume of the ambient noises.

The media player 10 includes a communicating unit 11, an instruction analyzing unit 12, an audio processing unit 13, and a video processing unit 14.

The communicating unit 11 receives the video compensation signal 20 and the audio compensation signal from the portable electronic device 20.

The instruction analyzing unit 12 analyzes the video compensation signals and the audio compensation signals, and transmits the video compensation signal to the video processing unit 14, and the audio compensation signal to the audio processing unit 13.

The video processing unit 14 adjusts the video frames displayed by the media player 10 based on the video compensation signal. In particular, the video processing unit 14 increases or reduce the luminance of the video being displayed by the media player 10 based on the color differences between the video frame image and the back ground view image.

The audio processing unit 13 adjusts the audio outputted by the media player based on the audio compensation signals. In particular, the audio processing unit 13 increases the volume of the audio from the player 10 in relation to all other noises in the ambient noises.

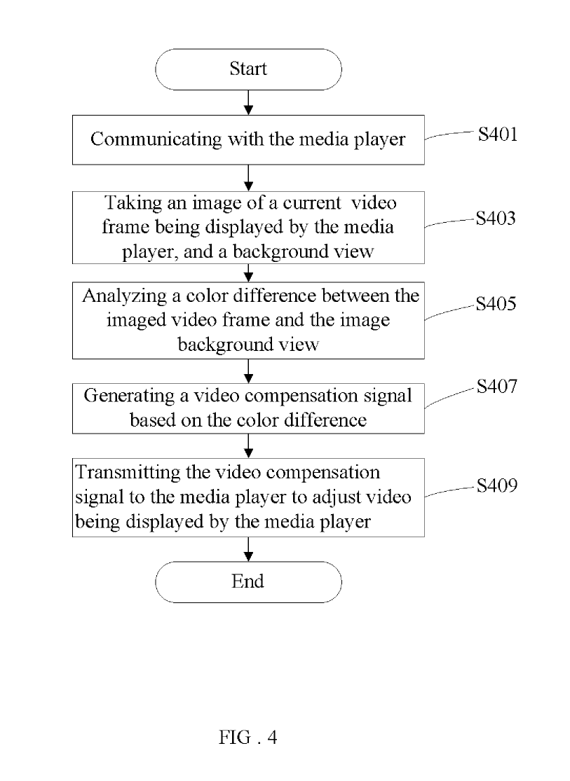

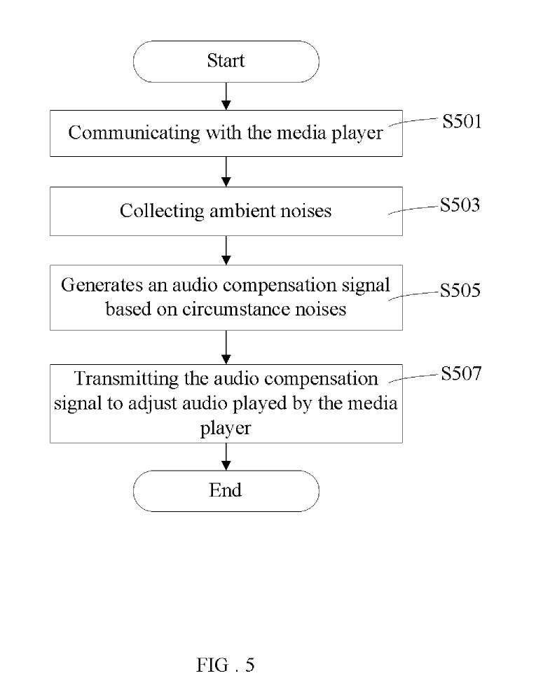

A control method controls a media player to output compensated video and audio. The control method includes a video control method (as shown in FIG. 4), and an audio control method (as shown in FIG. 5). In this embodiment, the video control method and the audio control method are executed asynchronously. In another embodiment, the video control method and the audio control method are executed simultaneously.

Referring to FIG. 4, the video control method executed by a portable electronic device includes steps of:

In step S401, communicating with the media player.

In step S403, taking an overall image, including a current video frame being displayed by the media player and a background view, the current video frame is imaged in a predetermined region, and the background is imaged outside the predetermined region.

In step S405, analyzing a color difference between the video frame image and the image background view. The color difference can be, but is not limited to being, a color temperature difference, a luminance difference, or both a color temperature and luminance difference.

In step S407, generating a video compensation signal based on the color differences between the current video frame image and the image background view.

In step S409, transmitting the video compensation signal to the media player to adjust the output of the video frames being displayed by the media player, based on the color difference.

Referring to FIG. 5, the audio control method includes steps of:

In step S501, communicating with the media player.

In step S503, collecting ambient noises.

In step S505, generates an audio compensation signal based on ambient noises. In the embodiment, the audio compensation signal can be an adjustment of the volume of the audio being outputted by the media player 10.

In step S507, transmitting the audio compensation signal to adjust audio being outputted by the media player. In the embodiment, the volume of the audio being played back is increased in relation to the volume of all other noises in the ambient noises.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A portable electronic device, for controlling playback of a media player, the media player displaying video, the portable electronic device comprising:
an image gathering unit to take an image of the media player containing a current video frame being displayed by the media player, and a background view around the media player;
an image analyzing unit to analyze a color difference between the current video frame image and the back ground view image, and to generate an image compensation signal based on the color difference; and
a communicating unit to transmit the image compensation signal to the media player to control the media player to adjust the video being displayed.

2. The portable electronic device of claim 1, wherein the current video frame image is formed within a predetermined region of the image gathering unit, and the back ground view image is formed outside the predetermined region.

3. The portable electronic device of claim 1, wherein the video compensation signal controls the media player to adjust colors of the displayed video based on the color difference between the current video frame image and the back ground view image.

4. The portable electronic device of claim 1, wherein the color difference between the current video frame image and the back ground view image is one of a color temperature and luminance differences between the current video frame image and the back ground view image.

5. The portable electronic device of claim 1, wherein the media player further outputs audio, the portable electronic device further comprises an audio gathering unit and an audio analyzing unit, the audio gathering unit is configured to gather ambient noises around the media player, and to generate an audio compensation signal when the ambient noises are gathered, and the communicating unit transmits the audio compensation signal to the media player to control the media player to adjust a volume of the audio being outputted.

6. The portable electronic device of claim 5, further comprising an instruction generating unit, the instruction generating unit generating a connecting instruction to control the communicating unit to communicate with the media player in response to a user's operation, the communicating unit generates a starting signal to control the video gathering unit and the audio gathering unit to start up.

7. The portable electronic device of claim 1, wherein the portable device is one of a portable compute and a mobile phone.

8. A control method, for controlling playback of a media player, the control method comprising steps of:
taking an image of a current frame of the video being displayed by the media player, and a background view around the media player;
analyzing a color difference between the current video frame image and the back ground view image, and to generate an image compensation signal; and
transmitting the image compensation signal to the media player to control the media player adjusting the video being displayed.

9. The control method of claim 8, wherein the current video frame image is formed within a predetermined region, the back ground view image is formed outside the predetermined region.

10. The control method of claim 8, wherein the video compensation signal controls the media player to adjust color of the displayed video based on the color difference between the current video frame image and the back ground view image.

11. The control method of claim 8, wherein the media player further outputs audio, the control method further comprising step of:
gathering ambient noises around the media player;
generating an audio compensation signal based on the ambient noises; and
transmitting the audio compensation signal to adjust the audio being outputted by the media player.

12. The control method of claim 11, wherein the compensation signal comprises a volume of the ambient noises that the media player adjusts a volume of the audio being outputted based on the volume of the ambient noises.
